(19) United States
(12) Patent Application Publication
(10) Pub. No.: US 2020/0320961 A1
(43) Pub. Date: Oct. 8, 2020

(54) DYNAMIC ILLUMINATION SYSTEM FOR AIRBORNE VEHICLES

(71) Applicants: Airbus Operations GmbH, Hamburg (DE); Airbus Operations S.L., Madrid (ES)

(72) Inventors: Matthijs PLOKKER, Hamburg (DE); Luc Jan HORNSTRA, Hamburg (DE); Frank NIELSEN, Hamburg (DE); Gabrielle De Brouwer, Getafe (ES)

(21) Appl. No.: 16/836,214

(22) Filed: Mar. 31, 2020

(30) Foreign Application Priority Data
Apr. 2, 2019 (EP) 19166850.8

(51) Int. Cl. G09G 5/38; B64D 47/02; G03B 21/60

(52) U.S. Cl. CPC G09G 5/38; B64D 47/02; G03B 21/60; G09G 2340/0464; G09G 2380/12; G09G 2360/144; B64D 2203/00

(57) ABSTRACT

An illumination system for illuminating outer aircraft components of an airborne vehicle, such as an aircraft, includes a light projection system configured to project visual imagery to an outer surface of the airborne vehicle, and a projection controller having a light control processor configured to control the operation of the light projection system on the basis of at least one of operational flight status of the airborne vehicle, geographical location of the airborne vehicle and configuration data of movable surfaces of the airborne vehicle or on ambient light measurement.

### CROSS-REFERENCE TO RELATED APPLICATION

This application claims priority to EP 19166850.8 filed Apr. 2, 2019, the entire disclosure of which is incorporated by reference herein.

### TECHNICAL FIELD

The disclosure herein pertains to a dynamic illumination system for airborne vehicles, airborne vehicles being equipped with such dynamic illumination systems and methods for dynamically illuminating outer aircraft components.

Although applicable for any kind of airborne vehicle, the disclosure herein and the corresponding underlying problems will be explained in further detail in conjunction with an aircraft. Airborne vehicles within the meaning of this disclosure include all types of vehicles that may be propelled through the air by force and/or supported by aerodynamic forces.

### BACKGROUND

Airborne vehicles commonly employ static pictures, logos or decals painted or attached to the outside of the vehicle hull. Sometimes, static white light is used to highlight some parts of the otherwise static visual appearance of the airborne vehicles. In any case, a static visual identity contributes only to a limited extent to the attention an airborne vehicle may be gathering. Specifically, for purposes of branding or advertisement revenues improved and aesthetically more attractive solutions need to be found since permanent paint or foil attachments are difficult and expensive to change in a short amount of time.

Some approaches in the prior art are based on projecting visual imagery onto moving surfaces by light projection systems on the ground. However, such systems rarely take the position and shape of the moving surfaces to be illuminated into account. Other approaches involve projection systems as part of airborne vehicles.

Documents DE 20 2016 105 862 U1 discloses a projection system for forming an image on an outer wall of an aircraft and an aircraft with such a projection system. Document FR 3 002 360 A1 discloses a method and a device for displaying with the aid of at least one laser source a dynamic image on a movable vehicle. Document EP 2 549 329 B1 discloses a projector system for displaying information in a dynamic manner on an aircraft.

However, there is a need for improved and more flexible solutions for correct and undistorted shape and positioning of projected imagery onto the surfaces to be illuminated.

### SUMMARY

It is one of the objects of the disclosure herein to improve an airborne light projection system for airborne vehicles in order to position the projected imagery more flexibly on outside components of the airborne vehicle.

According to a first aspect of the disclosure herein, an illumination system for an airborne vehicle includes a light projection system configured to project visual imagery to an outer surface of the airborne vehicle, and a projection controller having a light control processor configured to control the operation of the light projection system on the basis of at least one of operational flight status of the airborne vehicle, geographical location of the airborne vehicle and configuration data of movable surfaces of the airborne vehicle.

According to a second aspect of the disclosure herein, a method for illuminating outer aircraft components comprises projecting visual imagery to outer aircraft components of the aircraft using a light projection system of an illumination system of the aircraft, sending, from an illumination system control gateway of an avionics network of the aircraft, information items to a projection controller of the illumination system, the information items pertaining to at least one of operational flight status of the aircraft, geographical location of the aircraft and configuration data of movable surfaces of the aircraft, and varying or adapting, by a light control processor of the projection controller, the projected visual imagery on the basis of the information items pertaining to at least one of operational flight status of the aircraft, geographical location of the aircraft and configuration data of movable surfaces of the aircraft.

According to a third aspect of the disclosure herein, an airborne vehicle comprises an illumination system according to the first aspect of the disclosure herein. The airborne vehicle may be an aircraft and comprises at least one outer aircraft component to be illuminated. The light projection system of the illumination system is configured to project visual imagery to one or more of the at least one outer aircraft component. The airborne vehicle further comprises an avionics network having an illumination system control gateway coupled to an avionics network interface of the illumination system, the illumination system control gateway being configured to send information items to the projection controller of the illumination system on the basis of which the projected visual imagery to the one or more of the at least one outer aircraft component is varied, changed or adapted.

One idea of the disclosure herein is to provide an illumination system with the capabilities to dynamically react to the operational state and geographical location of an airborne vehicle, time of day, month or year, weather conditions and other external factors.

The illumination systems, airborne vehicles and methods of the disclosure herein permit commercial application of external lighting on the aircraft by the airline. Such commercial application enhances the branding, cross-branding or advertising opportunities by individualizing the visual appearance of an aircraft and by attracting more attention due to richer illumination scenarios. Advantageously, the illumination or projected imagery may be updated remotely and on the basis of the demands of an airline or owner of an aircraft. The content of the illumination or projected imagery may benefit from utmost flexibility. For example, it may be possible for the projected imagery to include projection of media content like advertisement and scenes, projection of short video sequences, projection of photographs, projection of still images, projection of graphical illustrations or ornamental symbols.

In other use cases, the illumination systems, airborne vehicles and methods of the disclosure herein may also permit more practical applications such as sharing messages between aircraft flying in formation. For example, military aircraft flying under radar silent mode may use light signalling codes during refuelling operations to avoid or hamper enemy detection. Sharing information by illuminated outer surfaces may allow for much higher complexity in the information exchanged and therefore possibly enhance efficiency of operation. In some cases, the illumination systems may act as a sender of light encoded information for other illumination systems having a light receiver interface to capture this information.

According to some embodiments of the illumination system, the illumination system may further comprise an avionics network interface which can be coupled to an illumination system control gateway of an avionics network of the airborne vehicle. In some embodiments thereof, the avionics network interface may a unidirectional data interface.

According to further embodiments of the illumination system, the light projection system may include a light source and an optical projection assembly. In some embodiments thereof, the light control processor may be used to control operational parameters of the light source and the optical projection assembly using corresponding control signals.

According to further embodiments of the illumination system, the light source may include at least one of halogen lamps, LEDs, OLEDs, and lasers. According to further embodiments of the illumination system, the light source may be configured to emit regular colored light on a single wavelength, multiple wavelengths or over one or more bands of emission wavelengths.

According to further embodiments of the illumination system, the light control processor may be configured to calculate and correct for movement of movable surfaces based on flight operational data provided to the light control processor from an avionics network of the airborne vehicle.

According to further embodiments of the illumination system, the projection controller may include a memory device configured to store configuration data and/or pre-loaded images, movies or pictures to be displayed via the light projection system. In some embodiments thereof, the projection controller may include an external interface over which the projection controller is connectable to an external configuration device.

### BRIEF DESCRIPTION OF THE DRAWINGS

The disclosure herein will be explained in greater detail with reference to exemplary embodiments depicted in the drawings as appended.

The accompanying drawings are included to provide a further understanding of the disclosure herein and are incorporated in and constitute a part of this specification. The drawings illustrate the embodiments of the disclosure herein and together with the description serve to explain the principles of the disclosure herein. Other embodiments of the disclosure herein and many of the intended advantages of the disclosure herein will be readily appreciated as they become better understood by reference to the following detailed description. The elements of the drawings are not necessarily to scale relative to each other. Like reference numerals designate corresponding similar parts.

FIG. 1 schematically illustrates an aircraft having a dynamical illumination system according to some embodiments of the disclosure herein.

FIG. 2 schematically illustrates a functional block diagram of a dynamical illumination system in conjunction with components of an avionics network on board of an aircraft according to other embodiments of the disclosure herein.

FIG. 3 schematically illustrates a flow diagram of a method for illuminating outer aircraft components according to yet another embodiment of the disclosure herein.

In the figures, like reference numerals denote like or functionally like components, unless indicated otherwise. Any directional terminology like “top”, “bottom”, “left”, “right”, “above”, “below”, “horizontal”, “vertical”, “back”, “front”, and similar terms are merely used for explanatory purposes and are not intended to delimit the embodiments to the specific arrangements as shown in the drawings.

### DETAILED DESCRIPTION

Although specific embodiments have been illustrated and described herein, it will be appreciated by those of ordinary skill in the art that a variety of alternate and/or equivalent implementations may be substituted for the specific embodiments shown and described without departing from the scope of the disclosure herein. Generally, this application is intended to cover any adaptations or variations of the specific embodiments discussed herein.

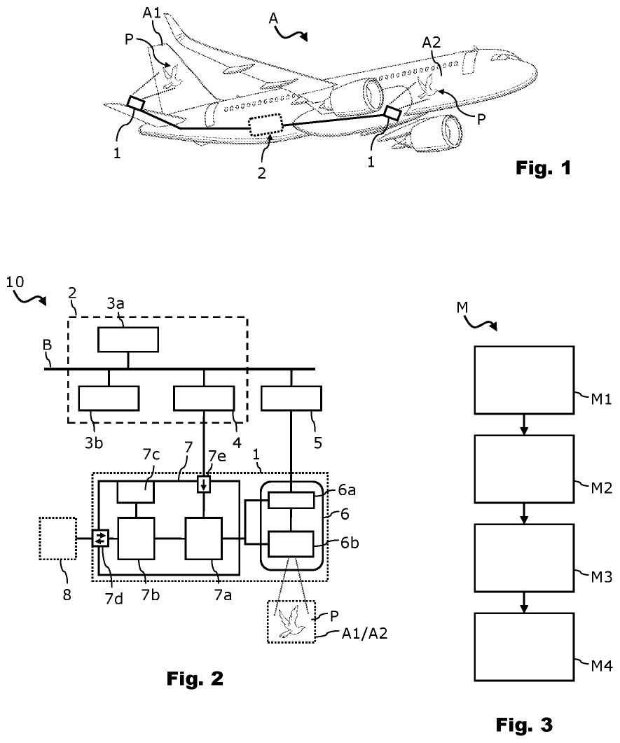

FIG. 1 shows a schematic illustration of an aircraft A having a dynamical illumination system 1 with illumination projectors and an avionics network 2 as part of an illumination system for the aircraft A. A functional block diagram explaining parts and elements of the illumination system architecture 10—as for example used in a vehicle such as the airborne vehicle exemplarily depicted with the reference numeral A in FIG. 1—is illustrated in FIG. 2. Airborne vehicles within the meaning of this disclosure include all types of vehicles that may be propelled through the air by force and/or supported by aerodynamic forces. Specifically, the illumination systems disclosed herein may also work on airborne vehicles temporarily located on the ground or near the ground. Finally, a flow diagram of a method M for illuminating outer aircraft components, such as outer aircraft components A1 or A2 of the airborne vehicle exemplarily depicted with the reference numeral A in FIG. 1 is exemplarily illustrated in FIG. 3. The method M may in particular employ an illumination system 1 and/or an illumination system architecture 10 as shown and explained in conjunction with FIG. 2.

The illumination system architecture 10 generally includes an avionics network 2 on board of an airborne vehicle, such as the aircraft A. The avionics network 2 may have a backbone B which is used to communicate between different network participants such as an aircraft flight control system 3a and cockpit systems 3b. The avionics network 2 includes an illumination system control gateway 4 that may be used to convey various information from the avionics network 2 and its network components to the illumination system 1. The illumination system control gateway 4 may particularly send information items from the avionics network 2 to the projection controller 7 on the basis of which external illumination of the aircraft A may be varied, changed or adapted.

The illumination system 10 generally includes a light projection system 6 and a projection controller 7 connected to the light projection system 6. The light projection system 6 may include a light source 6a, such as halogen lamps, LEDs or lasers which may in each case emit regular colored light on a single wavelength, multiple wavelengths or over one or more bands of emission wavelengths. The light emitted by the light source 6a may pass an optical projection assembly 6b having various lenses, mirrors and other optical equipment to form imagery P to be projected by the light projection system 6.

The projection controller 7 is used to control the content, brightness, fidelity, coloring and other parameters of the imagery P to be projected by the light projection system 6. To that end, the projection controller 7 includes a light control processor 7a operatively connected to either one or both of the light source 6a and the optical projection assembly 6b. The light control processor 7a may be used to control operational parameters of the light source 6a and the optical projection assembly 6b using corresponding control signals. The light control processor 7a may for example be a graphics processing unit (GPU). The light control processor 7a may use information items received from the avionics network 2 to modify positioning and/or shape of the projected content on the aircraft outer surfaces. In particular, the light control processor 7a may control the projected images to be spatially correctly positioned and visually neutral, i.e. neither distorted nor biased.

The projection controller 7 further includes a memory device 7b that is used to store configuration data and/or pre-loaded images, movies or pictures to be displayed via the light projection system 6. The memory device 7b may on one hand be provided with data to be stored via an external interface 7d over which the projection controller 7 may be updated or reconfigured remotely at any moment in time using a digital network connection to an external configuration device 8, such as a computer on a digital network (airline IT network, telecommunications network, satellite network, WiFi network, wireless local area network) or an electronic device (smartphone, tablet) connected to the external interface 7d. The external interface 7d may be a wired or wireless interface and may work bidirectionally.

In some configurations, the external interface 7d may be an optical interface specifically designed to capture optical input signal, such as for example projected imagery of illumination systems of other airborne vehicles. In such a configuration, two illumination systems of different airborne vehicles may act as senders and receivers of light communication (LiFi) between the two airborne vehicles.

On the other hand, the memory device 7b may be manually updated by using a physical connection to a removable memory card slot 7c in which a mobile storage device, such as an SD card may be inserted. Configuration data from the mobile storage device may then be transferred into the memory device 7b. The memory device 7b may store specifically prepared projection content which may have been prepared using a specific image mapping computer program adapted to take into account the surfaces onto which the imagery P is to be projected.

In some configurations, the projection content to be displayed may be derived from other aircraft data systems such as for example an in-flight entertainment system.

Illumination includes, but is not limited to, all types of illuminations or image projections on external surfaces of an aircraft A. For example, it may be possible for the projected imagery to include projection of media content like advertisement and scenes, projection of short video sequences, projection of photographs, projection of still images, projection of graphical illustrations or ornamental symbols. The external surfaces of the aircraft can be located anywhere on the aircraft and can be built from only one or from several different surfaces, either forming one combined surface together or being split in several different surfaces. For illumination of different surfaces, multiple illumination lights or projectors may be needed. For example, the tailfin A1 of an aircraft may be illuminated. In other variations, the hull A2 of the passenger cabin may be target of a light projection system 6.

Of course, other external surfaces, including moving or movable surfaces, may be target of one or more light projection systems 6 as well. In case of illumination of aircraft movable surfaces or parts thereof, a correction of the illumination direction would be possible. The light control processor 7a may calculate and correct for movement of the moving or movable surface based on flight operational data provided to the light control processor 7a from the illumination system control gateway 4 of the avionics network 2. Data for calculations of illumination corrections may be derived from movable calibration at airframe assembly. In some configurations it may be possible to include an illumination sensor (not explicitly depicted in the drawings) in the illumination system 1 in order to detect movement or positioning of the moving or movable surfaces by the light controller 7 itself. Such measurements of an illumination sensor, for example an infrared sensor or a LIDAR sensor, may be included in the illumination corrections performed by the light control processor 7a. Such sensor may also allow automatically turning the system on or off or dimming it accordingly to ambient light level.

Through the avionics network interface 7e, the avionics network 2 may periodically or constantly provide data items relating to operational flight status, geographical location of the aircraft or configuration data of aircraft movable surfaces to the light controller 7. The operational flight status may include parameters pertaining to the mode of operation of the aircraft, such as for example—but not limited to—the current flight altitude, the current airspeed, the current roll/pitch/yaw angles, the current flight or movement phase (ascent, descent, taxiing, cruise flight), the communication mode (e.g. radio silent mode) and other parameters. The geographical location may be derived from positioning or location systems within the aircraft.

The avionics network interface 7e may be a unidirectional interface, i.e. data may be transferred from the avionics network 2 to the light controller 7, but not the other way round. This provides additional security for the avionics network 2 from possible tampering with the illumination system 1. Generally, all content uploaded to the illumination system 1 may be carried out through secure network connections and the content may be checked and screened for malicious or faulty data items.

The light projection systems 6 may be powered using a power source 5 on board of the airborne vehicle, such as an electrical energy source. It may also be possible to provide Power over Ethernet (PoE), or Powerline Communication (PLC), to the light projection systems 6 along with the control signals from the light controller 7.

The method M for illuminating outer aircraft components (for example tailfins A1 or hull parts A2 of the aircraft) may include in a first stage M1 projecting visual imagery P to outer aircraft components A1; A2 of the aircraft A using a light projection system 6 of an illumination system 1 of the aircraft A. The light projection system 6 may for example include a light source 6a and an optical projection assembly 6b, with the light control processor 7a controlling operational parameters of the light source 6a and the optical projection assembly 6b using corresponding control signals.

Then, in a second stage M2 an illumination system control gateway 4 of an avionics network 2 of the aircraft A may send information items to a projection controller 7 of the illumination system 1. Those information items pertain to at least one of operational flight status of the aircraft A, geographical location of the aircraft A and configuration data of movable surfaces of the aircraft A.

In a third stage M3, a light control processor 7a of the projection controller 7 is be used to varying or adapt the projected visual imagery P on the basis of the information items pertaining to at least one of operational flight status of the aircraft A, geographical location of the aircraft A and configuration data of movable surfaces of the aircraft A. The information items may in some cases also include control signals sent out by the crew or passengers to change the projected content fully or partially.

Optionally, a fourth stage M4 may include calculating and correcting measures to be taken by the light control processor 7a, the calculating and correcting measures taking into account flight operational data from an avionics network 2 of the aircraft A. The correction measures aim to correct the light projection of the light projection system to account for movement of movable surfaces of the outer aircraft components A1; A2, such as for example horizontal or vertical trim operations of a tailfin A1.

In the foregoing detailed description, various features are grouped together in one or more examples or examples with the purpose of streamlining the disclosure. It is to be understood that the above description is intended to be illustrative, and not restrictive. It is intended to cover all alternatives, modifications and equivalents. Many other examples will be apparent to one skilled in the art upon reviewing the above specification. In particular, the embodiments and configurations described for the systems and aircraft infrastructure can be applied accordingly to the aircraft or spacecraft according to the disclosure herein and the method according to the disclosure herein, and vice versa.

The subject matter disclosed herein can be implemented in software in combination with hardware and/or firmware. For example, the subject matter described herein can be implemented in software executed by a processor or processing unit. In one exemplary implementation, the subject matter described herein can be implemented using a computer readable medium having stored thereon computer executable instructions that when executed by a processor of a computer control the computer to perform steps. Exemplary computer readable mediums suitable for implementing the subject matter described herein include non-transitory devices, such as disk memory devices, chip memory devices, programmable logic devices, and application specific integrated circuits. In addition, a computer readable medium that implements the subject matter described herein can be located on a single device or computing platform or can be distributed across multiple devices or computing platforms.

The embodiments were chosen and described in order to best explain the principles of the disclosure herein and its practical applications, to thereby enable others skilled in the art to best utilize the disclosure herein and various embodiments with various modifications as are suited to the particular use contemplated. In the appended claims and throughout the specification, the terms “including” and “in which” are used as the plain-English equivalents of the respective terms “comprising” and “wherein,” respectively.

While at least one example embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An illumination system for an airborne vehicle, the illumination system comprising:
a light projection system configured to project visual imagery to an outer surface of the airborne vehicle;
a projection controller having a light control processor configured to control operation of the light projection system on a basis of at least one of operational flight status of the airborne vehicle and geographical location of the airborne vehicle; and
an avionics network interface which can be coupled to an illumination system control gateway of an avionics network of the airborne vehicle, the avionics network interface being a unidirectional data interface.

2. The illumination system according to claim 1, wherein the light projection system includes a light source and an optical projection assembly, the light control processor configured to control operational parameters of the light source and the optical projection assembly using corresponding control signals.

3. The illumination system according to claim 2, wherein the light source includes at least one of halogen lamps, LEDs, OLED and lasers, the light source being configured to emit regular colored light on a single wavelength, multiple wavelengths or over one or more bands of emission wavelengths.

4. The illumination system according to claim 1, wherein the light control processor is configured to calculate and correct for movement of movable surfaces based on flight operational data provided to the light control processor from an avionics network of the airborne vehicle.

5. The illumination system according to claim 1, wherein the projection controller includes a memory device configured to store configuration data and/or pre-loaded images, movies or pictures to be displayed via the light projection system.

6. The illumination system according to claim 5, wherein the projection controller includes an external interface over which the projection controller is connectable to an external configuration device.

7. An aircraft, comprising:
at least one outer aircraft component to be illuminated;
an illumination system according to claim 1, the light projection system of the illumination system being configured to project visual imagery to one or more of the at least one outer aircraft component; and
an avionics network having an illumination system control gateway coupled to the avionics network interface of the illumination system, the illumination system control gateway being configured to send information items to the projection controller of the illumination system on a basis of which the projected visual imagery to the one or more of the at least one outer aircraft component is varied, changed or adapted.

8. A method for illuminating outer aircraft components of an aircraft, the method comprising:
projecting visual imagery to outer aircraft components of the aircraft using a light projection system of an illumination system of the aircraft;
sending, from an illumination system control gateway of an avionics network of the aircraft through an avionics network interface, information items to a projection controller of the illumination system, the information items pertaining to at least one of operational flight status of the aircraft and geographical location of the aircraft, the avionics network interface being a unidirectional data interface; and
varying or adapting, by a light control processor of the projection controller, the projected visual imagery on a basis of the information items pertaining to at least one of operational flight status of the aircraft, geographical location of the aircraft and configuration data of movable surfaces of the aircraft.

9. The method according to claim 8, wherein the light projection system includes a light source and an optical projection assembly, the light control processor controlling operational parameters of the light source and the optical projection assembly using corresponding control signals.

10. The method according to claim 8, further comprising:
calculating and correcting, by the light control processor, for movement of movable surfaces of the outer aircraft components based on flight operational data from an avionics network of the aircraft and/or on ambient light measurement.
